(19) United States
(12) Patent Application Publication
(10) Pub. No.: US 2002/0163218 A1
(43) Pub. Date: Nov. 7, 2002

(54) Vehicle shelf

(76) Inventors: Russell E. Stubbings, Denver, CO (US); Tony W. Brooks, Centralia, WA (US); Daniel Beaulaurier, Puyallup, WA (US); Craig M. Smith, Minnetonka, MN (US)

Correspondence Address: Mitchell P. Brook, LUCE, FORWARD, HAMILTON & SCRIPPS, 11988 EL CAMINO REAL, SUITE 200, SAN DIEGO, CA, 92130, US

(21) Appl. No.: 09/847,472

(22) Filed: May 2, 2001

(51) Int. Cl. B60R 7/00

(52) U.S. Cl. 296/37.7; 296/97.9

(57) ABSTRACT

A shelf for a vehicle interior is provided. The shelf comprises a front section configured to receive a visor, a center section structured to mount to the vehicle interior and a rear section configured to contact the vehicle interior. In one aspect of the invention, the shelf is attached to the vehicle interior only by the visor mounting system. When objects are placed on the shelf, a torque is produced about the mounting system and one edge of the shelf is designed to resist the torque.

### FIELD OF THE INVENTION

The present invention generally relates to motor vehicles, and more particularly, the invention concerns a shelf that can be installed in a vehicle interior.

### BACKGROUND OF THE INVENTION

Today, people are commuting longer distances and spending more time in their vehicles than ever before. Sport-utility vehicles are used for weekend getaways, and recreational vehicles have become second homes during vacations. Business is now conducted in automobiles with cell phones, fax machines, pagers, and even portable personal computers finding their way into vehicles. However, there is no storage space for these new additions. Glove compartments have a relatively limited capacity and are suitable for only storing small articles such as maps, owners' manuals and the like. Moreover, glove compartments are usually located on the passenger side of the dashboard and are difficult to reach from the driver's seat. This is particularly true in pickup trucks and sport-utility vehicles that have relatively wide dashboards. Other storage compartments include the small door compartments or the small storage compartment found between the seats. However, these compartments are usually filled with cassette tapes or compact discs.

One, possibly dangerous, result of this dearth of storage space is the placement of articles on the vehicle dashboard. Not only is this unsightly, but the driver's attention is distracted when articles begin to shift. Articles placed on the dashboard are also ruined or damaged by the sun. These articles also interfere with the operation with the vents located along the base of the windshield, interfering with airflow.

In an effort to provide additional storage space inside vehicles, various attempts have been made to secure shelves or other types of storage bins to the ceiling of the vehicle interior. Manufacturers have utilized the vehicle ceiling to locate small consoles that include environmental controls, lights and compartments for sunglasses or garage door openers. Vehicle after-market manufacturers have also designed shelves that extend across the width of the vehicle ceiling. To secure these shelves to the vehicle, holes must be drilled into the vehicle roof or ceiling. Not only are these holes unsightly but they also allow the ingress of moisture and water. Moreover, the complexity of the attachment systems for these shelves requires that they be installed by skilled automotive technicians, thereby increasing the cost of the shelves. In addition, these shelves are unsightly as they do not generally match the interior fit and finish of the vehicle.

Additionally, these shelves affect the vision or line-of-sight of tall vehicle operators. That is, the shelf extends down into the line-of-sight of an operator and can affect their ability to see objects located outside of the vehicle. Moreover, existing shelves change the location of the visor, resulting in a visor that is mounted and rotated in a fashion that is directly inverse to the factory installed position. Specifically, a visor designed and installed by the factory has a free end that is located near the vehicle operator. The vehicle operator rotates the free end of the visor down toward the vehicle windshield. In contrast, visors mounted on after-market shelves are positioned closer to the operator and the free end of the visor is now located adjacent to the windshield. The operator must then grab the free end of the visor and rotate it toward the operator. This greatly diminishes the effectiveness of the visor in blocking unwanted light as the free edge of the visor is farther away from the operator's eyes.

Therefore, there exists a need for a vehicle shelf that can accommodate the many items that find their way into today's vehicles, and can be installed without the drilling of any holes into the vehicle.

### SUMMARY OF THE INVENTION

The present invention alleviates to a great extent the disadvantages of conventional shelves by providing a shelf for a vehicle interior.

In one embodiment, the shelf includes a first section configured to receive a visor, a second section structured to mount to the vehicle ceiling and a third section configured to contact the vehicle interior. In a preferred embodiment, the shelf is attached to the vehicle by using the same fasteners that are used to attach the visor to the vehicle. This simple mounting procedure eliminates additional mounting brackets and the need for drilling holes into the vehicle and simplifies the installation process so that consumers can install the shelf.

In one aspect of the invention, the shelf is designed so that one end of the shelf opposes the weight of objects placed on the shelf. Specifically, a rear edge of the shelf is structured to conform with a surface of the vehicle ceiling and counteracts a torque that is created by placing objects on the front of the shelf. In this way, the shelf is stable and can be supported by using only the visor fasteners.

In another aspect of the present invention, the shelf includes one or more electrical power outlets that provide electrical energy to devices such as cell phones, personal digital assistants, radar detectors and other devices that may be placed on the shelf. In addition, the shelf may contain an anti-skid surface to prevent objects from shifting when the vehicle is underway. The shelf may also be constructed so that the surface matches the texture and color of the vehicle interior.

These and other features and advantages of the present invention will be appreciated from review of the following detailed description of the invention, along with the accompanying figures in which like reference numerals refer to like parts throughout.

### BRIEF DESCRIPTION OF THE DRAWINGS

FIG. 1 is a perspective view of one embodiment of the present invention installed on both the passenger side and driver side of a vehicle interior;

FIG. 2 is a perspective view of the embodiment illustrated in FIG. 1 configured to be installed on the passenger side of the vehicle;

FIG. 3 is a perspective view of the upper surface of another embodiment of the invention;

FIG. 4 is a perspective view of the lower surface the embodiment illustrated in FIG. 3; and

FIG. 5 is a sectional view of the embodiment illustrated in FIG. 4 installed in a vehicle.

It will be recognized that some or all of the Figures are schematic representations for purposes of illustration and do not necessarily depict the actual relative sizes or locations of the elements shown.

### DETAILED DESCRIPTION OF THE INVENTION

In the following paragraphs, the present invention will be described in detail by way of example with reference to the attached drawings. Throughout this description, the preferred embodiment and examples shown should be considered as exemplars, rather than as limitations on the present invention. As used herein, “the present invention” refers to any one of the embodiments of the invention described herein.

Conventional vehicle shelves require holes to be drilled into the vehicle or, at a minimum, brackets and other hardware must be installed before the shelf can be securely attached to the vehicle. These shelves are not configured to receive the visor and generally do not have a fit and finish that matches the color and textures of the vehicle interior. The brackets and other devices are required to securely mount the shelf so that it does not collapse under the weight of the objects placed on it. The challenge then becomes how to attach a shelf to a vehicle interior so that it can withstand the weight of objects, yet allow non-technical vehicle owners to install the shelf without having to attach brackets or drill holes into the vehicle.

One embodiment of the present invention contemplates a vehicle shelf that is attached to the ceiling of a vehicle by using only the fasteners that are used to attach the visor to the vehicle. In this way, installation of the shelf is simple and straightforward and can be accomplished by virtually any vehicle owner. Another embodiment can be attached to the vehicle by fasteners other than the visor fasteners, such as hook-and-loop fasteners, known as VELCRO (VELCRO is a trademark of Velcro Industries, a Netherlands Limited Liability Company), or Y-clips configured to fit underneath the vehicle trim, and other suitable fasteners.

In addition, the present invention provides a stable shelf that can withstand the weight of heavy objects by having one edge of the shelf contact a surface of the vehicle interior. This edge of the shelf counteracts the torque that is created about the visor fasteners by objects that are placed on the front of the shelf. In addition, the present invention also contemplates a shelf flange that can be inserted into an overhead console or window trim that further stabilizes the shelf.

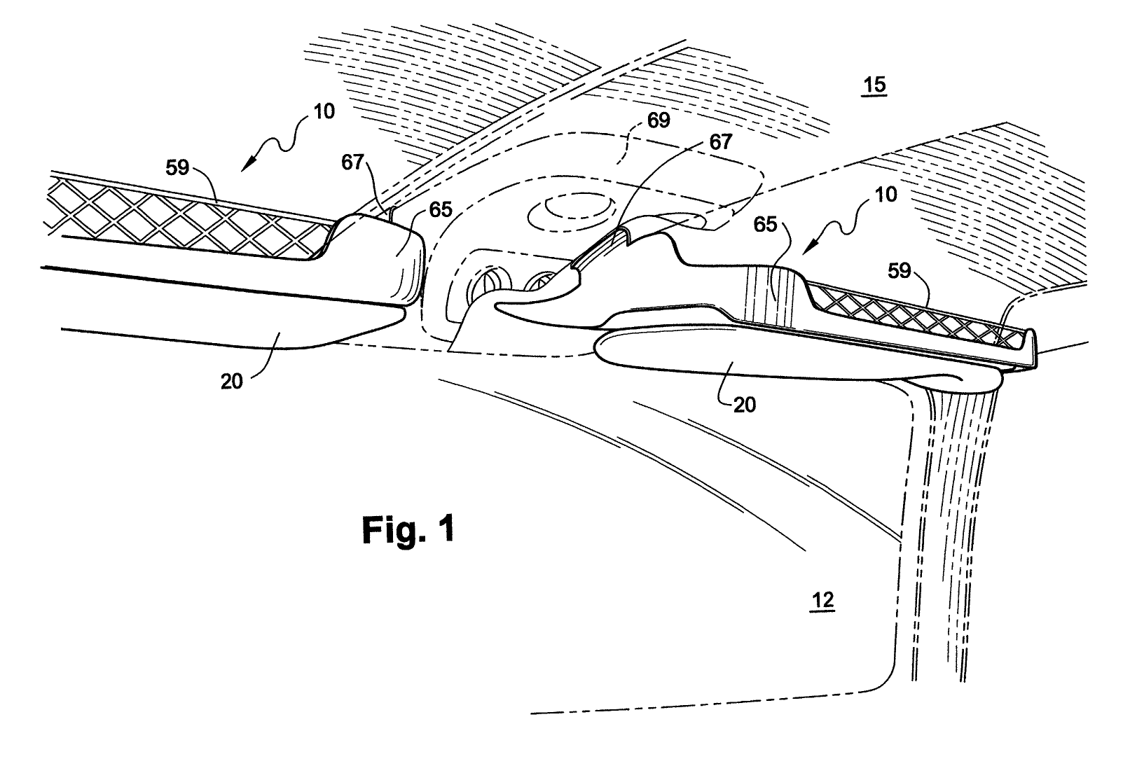

FIG. 1 illustrates one embodiment of the present invention installed in a vehicle interior. A vehicle shelf 10 is attached to the vehicle ceiling 15 adjacent to the windshield 12 so that the visor 20 can still be operated as intended by the manufacturer. The shelf 10 provides a storage location for a wide variety of articles and objects that can be easily placed and retrieved by either the driver or passengers.

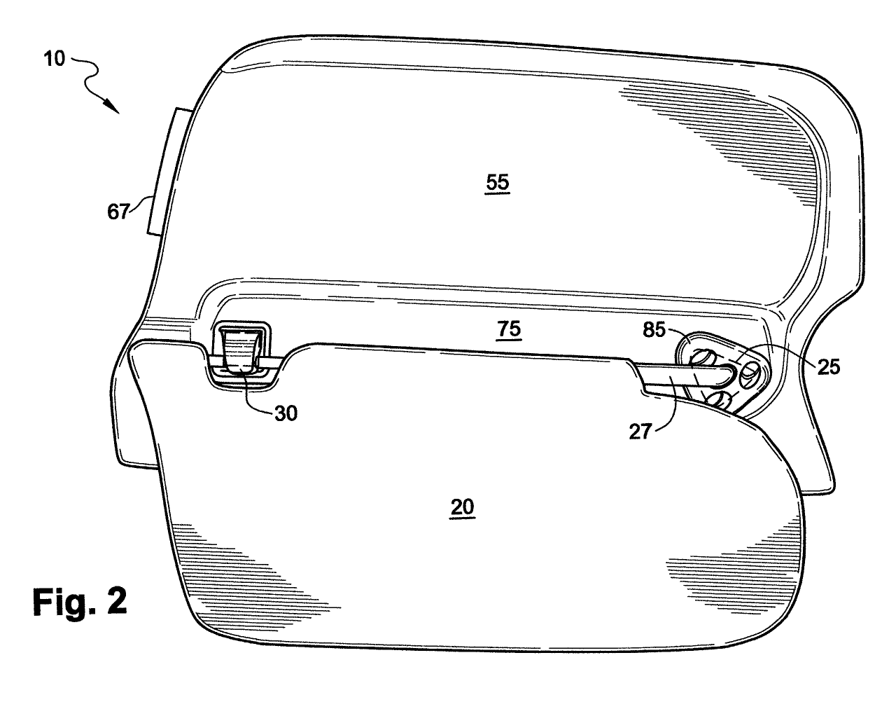

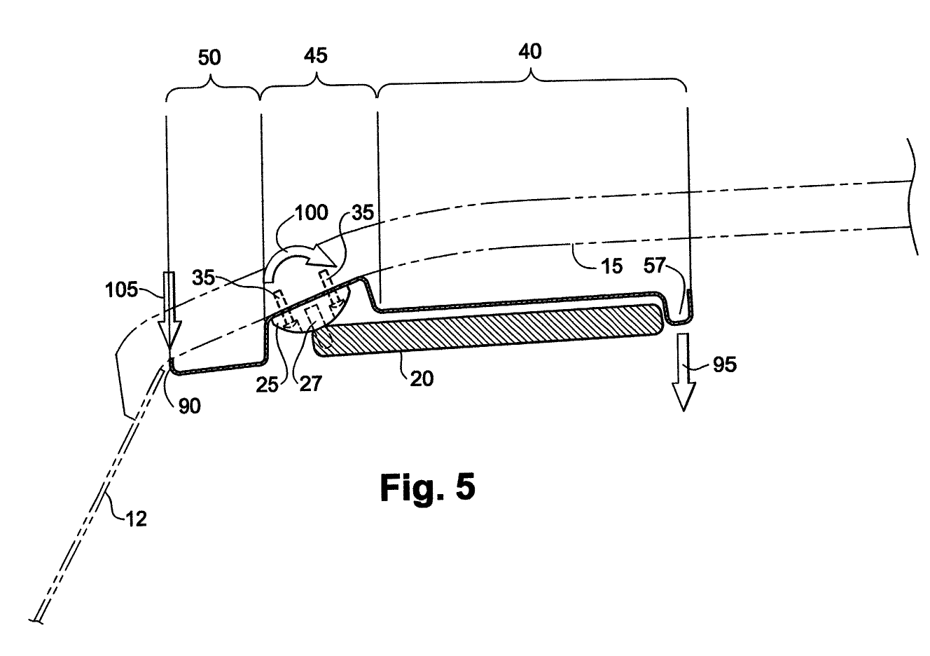

Referring to FIGS. 2 and 5, the visor 10 is attached to the vehicle ceiling by one or more visor fasteners 35. One possible procedure for installing the vehicle shelf 10 would include removing the visor by unfastening the visor fasteners 35 located in the visor base 25. The visor clip 30 would also then be removed from the vehicle ceiling 15. Once the visor 20 is removed from the vehicle ceiling 15 the shelf 10 is placed against the vehicle ceiling 15, as shown in FIG. 5.

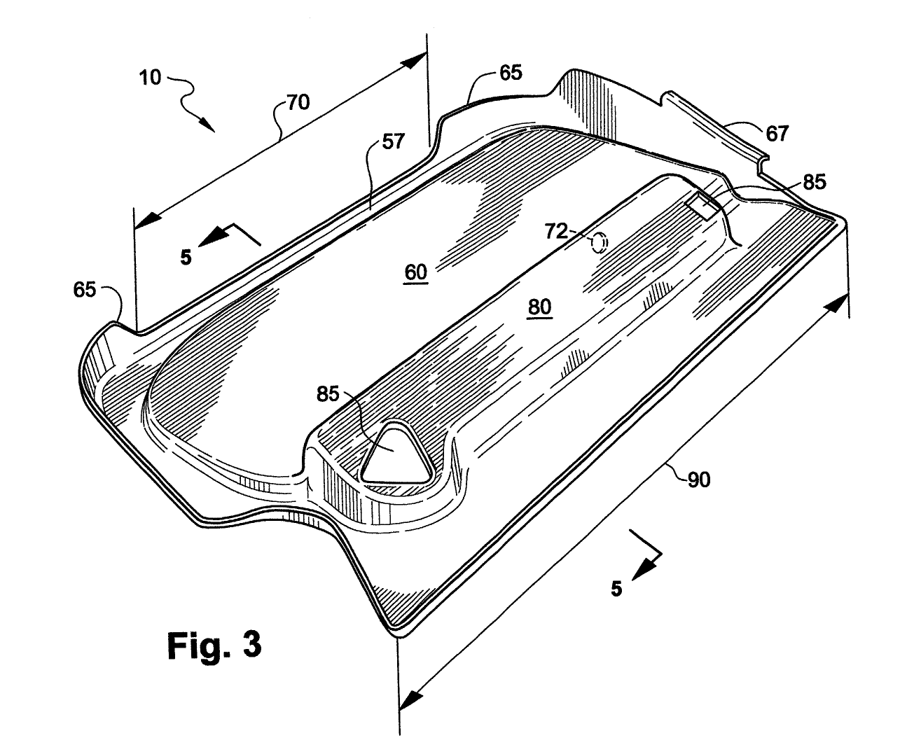

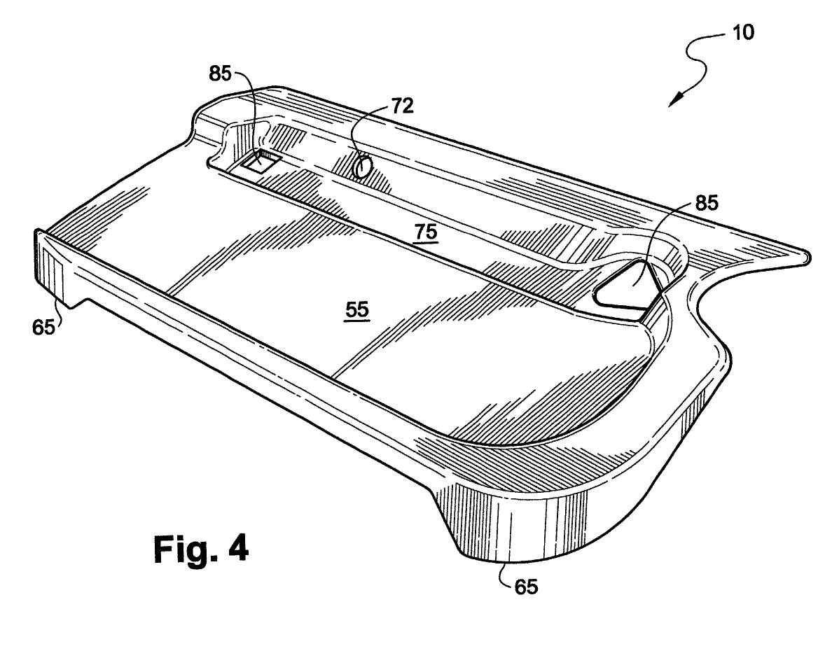

As shown in FIGS. 3 and 4, fastener apertures 85 are sized to receive the visor base 25 and visor clip 30. The visor base 25 is placed into the fastener aperture 85 and visor fasteners 35 are reinstalled in their original location. Visor clip 30 is also installed back in its original position in vehicle ceiling 15. Visor base 25, that in some visor designs is connected to visor arm 27, now captures the area around the visor aperture 85 and retains the shelf 10 against the vehicle ceiling 15 as shown in FIG. 2. In a similar fashion, visor clip 30 also retains the shelf 10 against the vehicle ceiling 15. Another embodiment of the invention may employ different visor fasteners 35 that may be slightly longer than the original vehicle fasteners. One advantage of the present invention is that the simple procedure described above to install the vehicle shelf 10 can be performed by virtually any vehicle owner.

Another embodiment of the present invention is configured for installation into vehicles that have visors 20 that are mounted to the vehicle ceiling 15 only by a visor base 25. These types of visors 20 do not have visor clips 30. A vehicle shelf 10 configured for these types of visors 20 would only have a single fastener aperture 85, an could employ hook-and-loop fasteners, or other suitable fasteners to attach the vehicle shelf 10 to the vehicle interior. For example, a flange 67 may be arranged on the vehicle shelf 10 to fit between the vehicle ceiling 15 and the steel roof of the vehicle, or a section of hook-and-loop fasteners may attach the vehicle shelf 10 to the vehicle ceiling 15.

Referring to FIGS. 3-5, the shelf 10 includes three sections: a first or front section 40; a second or elevated section 45; and a third or rear section 50. The front section 40 includes a visor pocket 55 on a lower surface of the shelf 10 that also acts as a reinforcement rib 60 on an upper surface of the shelf 10. Wall 65 extends around a perimeter of the front and elevated sections of the shelf 10 and serves several functions. As shown in FIG. 1, the wall 65 meets with the vehicle ceiling 15 creating an enclosure that prevents articles from falling off of the shelf 10. In one embodiment of the present invention, a flange 67 can be formed into the wall 65. The flange 67 can be placed between an overhead console 69 and the vehicle ceiling 115 or the flange 67 can be placed between a window molding and the vehicle interior. When installed in this manner, the flange 67 provides additional support to the shelf 10, shown in FIGS. 1 and 4.

As shown in FIG. 1, the visor pocket 55 is sized to receive a visor 20. The reinforcement rib 60 (shown in FIG. 3) on the upper surface of the front section 40 strengthens the shelf 10 and also provide a narrow basin 57 that is formed between the stiffening rib 60 and the wall 65. The narrow basin 57 can be accessed through the cutaway section 70 located in the wall 65. Pens, sunglasses, rulers and other long objects fit securely in the narrow basin 57. Illustrated in FIG. 1, one embodiment of the present invention includes a net 59 placed across the cutaway section 70. The net 59 retains objects placed on the shelf 10 but allows easy access to the same objects. The net 59 can be constructed of elastic materials but it will be appreciated that a mesh, screen or other types of materials or designs can also be employed to enclose the cutaway section 70. Alternatively, the shelf 10 may not include a cutaway section 70 and therefore would not require a net 59. In addition, the shelf 10 may include a cutaway section 70 without a net 59.

Referring to FIGS. 3-5, the elevated section 45 is structured to engage the vehicle ceiling 15. As shown in FIG. 4, the elevated section 45, when viewed from below, resembles a long rectangular recess 75. Referring now to FIGS. 3 and 5, when viewed from the side or when viewing the upper surface, the recess 75 appears as a mating surface 80. The mating surface 80 of the elevated section 45 is configured to securely mate or conform with the vehicle ceiling 15. This mating surface 80 may change in shape to conform to different vehicle interiors. For example, the vehicle ceiling 15 may have a slightly different contour from vehicle to vehicle and therefore, the mating surface 80 will also have a different shape. As shown in FIGS. 3 and 4, the main section 45 includes two fastener apertures 85 sized to receive the visor clip 30 and the visor base 25. The exact arrangement and configuration of the fastener apertures 85 will also vary depending upon the design and arrangement of the visor clip 30 and visor base 25 in each specific vehicle.

Also illustrated in FIG. 3 is a power outlet 72 that provides electrical power for devices placed on the shelf 10. The power outlet 72 may be a 12-volt adapter, a lighter socket assembly or other device that provides electrical power. In one embodiment of the invention, the power outlet 72 may be optionally installed and comprise a 12-volt adapter that connects with the vehicle electrical system.

Referring to FIGS. 3-5, adjacent to the elevated section 45 is the third or rear section 50. The rear section extends several inches from the elevated section 45 and is substantially planar. The rear section 50 terminates in an edge 90 that includes a small lip. When installed, the edge 90 is configured to securely engage the surface of the vehicle ceiling 15, shown in FIG. 5. The length and width of the rear section 50 and edge 90 will vary depending upon the vehicle ceiling design. An alternative embodiment of the present invention may include a rear section 50 that does not include a lip but simply extends a substantially planar edge 90. Alternatively, the rear section 50 may not be planar, but comprise two or more finger-like extensions that extend from the elevated section 45 and contact the vehicle ceiling 15. Moreover, edge 90 may not engage the surface of the vehicle ceiling 15 along its entire length. That is, sections of the edge 90 may contact the vehicle ceiling 15, and other sections of the edge 90 may not contact the vehicle ceiling 15.

Referring to FIG. 5, the counter-torque support feature of the rear section 50 is illustrated. One advantage of the present invention is that the shelf 10 can be installed and secured to a vehicle ceiling 15 by only using the visor fasteners 35 associated with the visor 20. No brackets or other devices are necessary for installing the shelf 10 to a vehicle ceiling 15. This simple installation is possible, in part through the configuration of the shelf 10 and how it engages the vehicle ceiling 15. Referring to FIG. 5, the mating surface 80 engages the vehicle ceiling 15 after the visor base 25 and visor fastener 35 have been installed. The shelf 10 is configured so that when the mating surface 80 of the main section 45 is engaged with the vehicle ceiling 15, the edge 90 of the rear section 50 also contacts and securely abuts the vehicle ceiling 15. The edge 90 provides a second contact area to supplement the first contact area established by the mating surface 80. This stabilizes and supports the vehicle shelf 10 on the vehicle ceiling 15. Another aspect and advantage of this attachment concept is that when objects are placed on the front section 40, they produce a downward force 95. The downward force 95 pulls the front section 40 downward away from the vehicle ceiling 15. This creates a torque 100 about the visor fastener 35. Counteracting the torque 100 is the edge 90 of the rear section 50. As the front section 40 is pulled downward, the rear section 50 is pushed upward against the vehicle ceiling 15. Therefore, the downward force 95 is resisted by an equal and opposite force 105 that acts through the rear section edge 90. This counteracting torque feature provided by the edge 90 of the present invention allows the shelf 10 to be installed in a vehicle ceiling 15 by only using the visor fasteners 35. However, it will be appreciated that other types of fasteners can be employed to attach the shelf 10 to the vehicle ceiling 15.

It will be appreciated that the vehicle shelf 10 of the present invention can be installed in any type of vehicle including passenger cars, pickup trucks, commercial trucks, sport-utility vehicles, recreational vehicles, vans, buses, farm vehicles, and commercial semi-trailer vehicles. A vehicle shelf 10 constructed according to the present invention may have different physical dimensions to conform to the different vehicle ceiling 15 and visor 20 arrangements found in each vehicle. For example, the edge 90 may be shorter and the rear section 50 may extend a greater or lesser distance from the main section 45. The visor pocket 55 may be sized to receive different sized visors 20 and the wall 65 may have a different configuration to follow the contour of different vehicle ceilings 15. Also, the flange 67 may be located in different areas on the wall 65 to conform with different vehicle interiors.

In one embodiment, the vehicle shelf 10 is constructed of a vacuum formed plastic that is manufactured in a suitable mold that would include the same texture or surface pattern found on other plastic parts of the vehicle interior. For example, many vehicle interiors include plastic components that have a texture or surface pattern that resembles leather or other materials. A preferred embodiment of the present invention would match the texture or surface finish of the other plastic components found in the vehicle. In addition, the color of the plastic components or the vehicle ceiling would also be matched by the color of the vehicle shelf 10. In this way, the vehicle shelf 10 would have the appearance of an original-equipment manufactured component. However, the shelf 10 may be manufactured by other methods, may be constructed of other suitable materials, and may also be colored to contrast with the vehicle interior.

Thus, it is seen that a vehicle shelf is provided. One skilled in the art will appreciate that the present invention can be practiced by other than the preferred embodiments, which are presented in this description for purposes of illustration and not of limitation, and the present invention is limited only by the claims that follow. It is noted that various equivalents for the particular embodiments discussed in this description may practice the invention as well.

What is claimed is:

1. A shelf for a vehicle interior, comprising:
a front section configured to receive a visor;
an elevated section structured to couple to the vehicle interior; and
a rear section configured to contact the vehicle interior.

2. The shelf of claim 1, wherein a width of the shelf is substantially equal to a width of the visor.

3. The shelf of claim 1, wherein the front section comprises a lower surface and an upper surface, with the lower surface configured to receive a visor, and the upper surface configured to receive one or more objects.

4. The shelf of claim 1, further comprising a net coupled to the front section.

5. The shelf of claim 1, further comprising a wall element extending from at least one of the front section or the elevated section.

6. The shelf of claim 5, wherein the wall element extends along an edge of the elevated section and around the front section.

7. The shelf of claim 5, wherein the wall element is configured to engage a surface of the vehicle interior.

8. The shelf of claim 1, wherein the elevated section is configured to engage a surface of the vehicle interior.

9. The shelf of claim 1, wherein the elevated section comprises at least one aperture configured to receive a visor fastener.

10. The shelf of claim 1, wherein the elevated section comprises at least one aperture configured to receive a visor clip.

11. The shelf of claim 1, wherein the rear section comprises a edge configured to contact a surface of the vehicle interior.

12. The shelf of claim 1, wherein a surface of the shelf includes an anti-skid surface.

13. The shelf of claim 12, wherein the anti-skid surface is selected from the group consisting of: a flocked surface, a textured surface, a matted surface, and an anti-skid surface.

14. The shelf of claim 1, further comprising an electrical power source coupled to the shelf.

15. The shelf of claim 1, wherein the shelf includes a surface texture that is matched to a vehicle interior surface texture.

16. The shelf of claim 1, wherein a color of the shelf matches a vehicle interior color.

17. The shelf of claim 1, wherein the shelf is configured for installation in a vehicle selected from the group consisting of: passenger vehicles, trucks, pickup trucks, recreational vehicles, sport-utility vehicles, vans, buses and semi-trailer vehicles.

18. A shelf for a vehicle interior, comprising:
a first section comprising a lower surface and an upper surface, the lower surface configured to receive a visor, with the upper surface configured to receive one or more objects; and
a second section structured receive a visor fastener, the visor fastener coupling the shelf to the vehicle interior.

19. The shelf of claim 18, wherein the second section comprises an aperture structured to receive a visor clip, the visor clip coupling the shelf to the vehicle interior.

20. The shelf of claim 19, wherein only the visor fastener and the visor clip couple the shelf to the vehicle interior.

21. The shelf of claim 18, further comprising a third section extending from the second section and structured to contact a surface of the vehicle interior.

22. The shelf of claim 18, wherein a width of the shelf is substantially equal to a width of the visor.

23. The shelf of claim 18, wherein a lower surface of the first section includes a recess for receiving the visor.

24. The shelf of claim 18, wherein the second section comprises an elongated pocket for receiving a visor mount comprising a visor fastener and a visor base.

25. A shelf for a vehicle interior, comprising:
an elevated section comprising at least one attachment aperture configured to receive a fastener for mounting the shelf to the vehicle interior;
a front section configured to receive one or more objects, with a weight of the objects creating a moment about the fastener; and
a rear section configured to contact a vehicle surface, thereby opposing the weight, and creating a counter-moment.

26. The shelf of claim 25, wherein the moment comprises a torque about the fastener, and the rear section opposes the moment by exerting a force against the vehicle surface.

27. The shelf of 25, wherein the elevated section comprises a second attachment aperture configured to receive a second fastener.

28. The shelf of claim 25, wherein the fastener is selected from the group consisting of: visor bases, visor fasteners, bolts, threaded fasteners, non-threaded fasteners, quick-connect devices and other suitable fasteners.

29. A method of attaching a shelf to a vehicle interior, the method comprising the steps of:
providing a shelf with at least one attachment aperture located in an interior area of the shelf;
attaching the shelf to the vehicle interior by placing a fastener though the attachment aperture;
positioning a rear section of the shelf against the vehicle interior so that a weight placed on the shelf is resisted by the rear section contacting the vehicle interior.

30. The method of claim 29, wherein the step of attaching the shelf to the vehicle interior comprises:
removing a visor from the vehicle interior;
positioning the shelf in the vehicle interior;
re-attaching the visor to the vehicle interior so that the shelf is captured between the visor and the vehicle interior.

31. The method of claim 30, wherein the step of attaching the shelf to the vehicle interior further comprises:
re-attaching the visor to the vehicle interior so that the shelf is captured between the vehicle interior and one or more vehicle components selected from the group consisting of: headliners, overhead consoles, window trim, and window moldings.

32. The method of claim 29, wherein the weight creates a moment about the attachment aperture, and the rear section resists the moment by contacting the vehicle interior.
